(19) United States
(12) Patent Application Publication
(10) Pub. No.: US 2019/0105813 A1
(43) Pub. Date: Apr. 11, 2019

(54) METHOD FOR FORMING VOLUMETRIC BODIES

(71) Applicant: HOMAG Bohrsysteme GmbH, Herzebrock-Clarholz (DE)

(72) Inventor: Thomas BETTERMANN, Bielefeld (DE)

(73) Assignee: HOMAG Bohrsysteme GmbH, Herzebrock-Clarholz (DE)

(21) Appl. No.: 15/763,434

(22) PCT Filed: Sep. 30, 2016
(86) PCT No.: PCT/EP2016/073441

§ 371 Date: Mar. 26, 2018

(30) Foreign Application Priority Data
Oct. 2, 2015 (DE) 10 2015 219 135.4

(51) Int. Cl. B29C 41/52; B29C 64/106; B29C 41/08; B29C 41/46; B29C 41/22; B33Y 10/00; B33Y 70/00

(52) U.S. Cl. CPC B29C 41/52; B29C 64/106; B29C 41/08; B29K 2995/0056; B29C 41/22; B33Y 10/00; B33Y 70/00; B29C 41/46

(57) ABSTRACT

The invention relates to a method for forming volumetric bodies (100), for example of elements from the furniture or component industries, comprising the steps of: foaming an application material, applying the application material in order to form a volumetric body in several segments, and adjusting the pore size of the foamed application material depending on the segment of the volumetric body in question.

### FIELD OF THE INVENTION

The present invention relates to a method for forming volumetric bodies, in particular elements of pieces of furniture and/or elements of the building materials industry.

### PRIOR ART

WO 2013/180609 A1 is known which relates to a method and to a device for forming an object layer by layer. This layered or additive formation of bodies falls within the domain of generative methods and can therefore be assigned to so-called 3D printing.

The particular advantage of such methods is that volumetric bodies can be constructed in a wide variety of geometries. Complex geometries are also possible here by means of the additive application of material.

Since the materials are applied step by step, each new layer can, however, only be applied to an already existing layer. What initially sounds like a triviality has far-reaching consequences for the finished volumetric body because the necessarily solid construction entails long production times and disproportionately high component weights.

### SUMMARY OF THE INVENTION

It is an object of the present invention to provide a method for the production of volumetric bodies which enables faster production speeds and a reduction of the weight of the finished volumetric bodies.

A basic idea of the present invention here is to resort to an application material that can be foamed, and to adjust the pore size of the foamed application material depending on the corresponding point of the volumetric body to which the application material is applied.

In particular, for this purpose the present invention provides a method for forming volumetric bodies according to claim 1. Additional preferred embodiments are specified in the dependent claims.

Thus, a method for forming volumetric bodies, in particular elements of pieces of furniture and/or elements of the building materials industry, comprises the steps: foaming an application material, applying the application material in order to form a volumetric body in several segments, and adjusting the pore sizes of the foamed application material depending on the respective segment of the volumetric body.

The term “volumetric body” is to be understood here to be a structural body, the dimensions of which go beyond a coating or a printed surface. In particular, the volumetric body should have a thickness of at least 500 μm.

The pore size is measured here according to the pore size of the foamed application material, i.e. according to the pore size in the finished volumetric body. Care should be taken here to ensure that, for example, after dispensing the application material, “post-expansion” can still take place which can, however, be controlled by appropriate measures, and so also falls under the adjusting or varying of the pore size.

By foaming the application material, a particularly light base material for the volumetric body can first of all be used. Furthermore, by means of the foaming, the pores in the application material which is porous due to the foaming, are distributed randomly which, despite the saving in weight, nevertheless gives rise to a very solid structure of the volumetric body. By adjusting the pore sizes dependently upon the corresponding segment of the volumetric body, one can furthermore commit better to the desired properties of the finished volumetric body. For example, the pore size can be adjusted here taking into account the desired hardness of the corresponding segment. The desired surface finish in the external and accessible segments of the volumetric body can also be adjusted appropriately.

Overall, one can thus obtain a particularly light volumetric body which can be matched flexibly to the desired use. By means of the foaming, appropriate segments of the volumetric body can, furthermore, be produced particularly quickly.

The steps of the method specified above and in claim 1 are not set in any specific sequence. Thus, the foaming can be carried out, for example, after, before or during the deployment of the application material.

The foaming of the application material can be understood to the effect that it comprises the step of initiating the foaming.

Preferably, the initiation of the foaming takes place before or during the deployment of the application material.

This is beneficial not only to the controllability of the foaming process, but also allows shorter production times.

Alternatively, the foaming can also only be initiated after deploying the application material. This works, for example, by a correspondingly designed application material being used in which the foaming is only triggered after deployment (for example by reacting with oxygen in the air).

Preferably, the application constitutes an additive or generative process in which the application material is applied successively, layer by layer, in order to form the volumetric body successively, segment by segment.

The advantage of additive material application here is that complex geometries and a wide variety of volumetric bodies can also be formed by one and the same method and using one and the same set of tools, and that a highly stable composite is guaranteed within the volumetric body.

Preferably, the adjustment of the pore size of the foamed application material includes a variation of the pore size between the segments of the volumetric body, depending on the respective segment of the volumetric body.

The advantage of this is that, for example, in appropriate segments of the volumetric body a large pore size can be chosen, and this gives rise to material savings, and so to a weight reduction of the volumetric body and accelerated production. In other regions which are, for example, subjected to greater stresses structurally, a smaller pore size can then be chosen in order to make the volumetric body more resistant in these segments, and possibly to provide it with a greater hardness. Smaller pore sizes may also contribute to a more attractive appearance of the volumetric body. Overall therefore, the flexibility in the design of the volumetric body increases, while at the same time saving weight.

Preferably, the pore size is adjusted continuously during application.

The continuous adjustment relates here to the application process and means that the actual process of forming the volumetric body is not interrupted by adjusting the pore size. If the pore size is to be adjusted from one segment to another segment of the volumetric body, this may in other words take place continuously during the application. Consequently, the aforementioned continuous adjustment of the pore size does not mean (or does not necessarily mean) that the pore size also varies continuously in the volumetric body. The pore size in itself may also change in jumps or inconsistently, the change taking place continuously, however, during the application in relation to the process.

Preferably, the pore size is adjusted such that the foamed application material has a smaller pore size for external segments of the volumetric body than the foamed application material for internal segments of the volumetric body.

The external segments designate here the accessible or visible segments of the volumetric body. By making the aforementioned adjustment, an attractive external appearance, for example, can be achieved for external segments. The hardness of the external segments of the volumetric body can also be increased, and this further promotes structural stability without increasing the weight.

It is also preferred here if the external segments of the volumetric body (i.e. the foamed application material for the external segments) have a smaller pore size than the internal segments of the volumetric body (i.e. the foamed application material for the internal segments).

In other words, the whole of the outer shell, i.e. all of the external, accessible and visible segments, has a smaller pore size than the internal segments. Thus, a cohesive shell with low porosity is formed, which is in turn beneficial to the appearance, the outward hardness and the stability of the volumetric body.

According to a further development, additives can be specifically added to the application material, the addition of the additives likewise taking place depending on the respective segment of the volumetric body.

The additives are preferably designed such that they influence the physical properties (such as hardness, colour, surface finish) of the foamed application material, the addition of the additives adjusting the physical properties of the foamed application material depending on the respective segment of the volumetric body, and in particular being varied from segment to segment.

The additives include, for example, hardeners, pigments or colourants and surface-changing supplementary materials by means of which the hardness, the surface appearance and the colour in the corresponding segments of the volumetric body can be influenced. It is thus conceivable, for example, to add particular colourants for external segments of the volumetric body which provide the volumetric body overall with the desired colour appearance. Consequently, within the framework of this further development, the degree of freedom with regard to the rapid production of a light volumetric body can also be further increased.

For example, the foaming can take place (or be initiated) by means of the specific addition of a propellant gas, in particular nitrogen or carbon dioxide, and the pore size of the application material is adjusted by varying the addition of the propellant gas (or by the amount of propellant gas that is added).

It is preferred here if the propellant gas is in cryogenic form or is added as cryogen, such as for example in the form of liquid nitrogen or dry ice (frozen carbon dioxide).

The variation or adjustment of the pore size on the basis of the addition of a propellant gas constitutes a very easily controllable method of specifically adjusting the pore size. If, for example, more propellant gas is added, larger pores are immediately obtained, and vice versa. Furthermore, the ratio of action to reaction can be anticipated very easily. This means that in other words, it can easily be calculated which addition of propellant gas leads to which porosity.

Furthermore, an advantage of adding the propellant gas as cryogen is easy manageability (especially with regard to metering). Within the heated application material boiling or sublimation of the cryogenic propellant gas then takes place, and this generates (initiates) a foaming effect. At the very latest when deploying the application material, foaming of the latter therefore takes place.

Alternatively, it is preferred to mix foaming agents with the application material, which agents are particularly suitable for unfolding their foaming effect temperature-dependently.

Therefore, the pore size of the application material can be adjusted by varying the temperature of the application material. This has advantages in particular with regard to the process sequence because the temperature must in any case be controlled when applying the application material, for example with an extruder, in order to guarantee the desired material properties of the application material during application.

Preferably, the temperature-dependent application of the foaming effect is a continuous, temperature-dependent change of the foaming effect.

Alternatively, the temperature-dependent application of the foaming effect constitutes a transition temperature at which the foaming effect of the foaming agent is activated (initiated), and the pore size of the application material is adjusted within a range around the transition temperature, in particular when applying the application material, by varying the temperature of the application material.

Therefore, the pore size for forming the volumetric body can in this way be adjusted very accurately, and at the same time very easily, by the foaming agent being “switched on and off” at the transition temperature.

Also preferably, two types of foaming agent are mixed with the application material, the first type applying its foaming effect at a first temperature, and the second type applying its foaming effect at a second temperature which is different from the first temperature, and in particular when applying the application material, the pore size of the application material is adjusted by varying the temperature of the application material within a range around the second temperature.

The provision of this type of application material with the aforementioned properties makes it possible to adjust the pore size for forming the volumetric body very precisely and at the same time very easily. Thus, by varying the temperature of the application material within a range around the second temperature, the second type can be “switched on and off”. The switching on or activation can take place depending on the choice of the first and the second temperature when transitioning to hotter or colder temperatures. If the second type is “switched on” or activated, the foaming effect is greater overall and the porosity increases accordingly.

According to a preferred embodiment, the second temperature is higher than the first temperature.

Thus, volumetric bodies which have two different porosities from segment to segment can be formed easily. Resorting to a definite transition temperature (i.e. the second temperature) constitutes an easily managed, effective and very precise tool here for obtaining the desired properties.

According to a further development the method makes provision such that the variation of the temperature of the application material within a range around the second temperature includes active cooling of the application material.

By means of the active cooling the temperature of the application material can be specifically brought to below the second temperature, and this further improves the manageability of the method by means of the shortened reaction time upon the transition to the smaller pore size.

Also preferably, two components are added to the application material, the two components being designed so that when mixed with one another, and in particular by reacting with one another, they apply a foaming effect for foaming the application material (i.e. they initiate foaming), and the foaming effect is dependent upon the ratio of the two components. The method then additionally includes the step of adjusting the pore size of the application material by varying the ratio of the two components in the application material.

The “ratio” can relate here, for example, to the weight, the volume or the stoichiometric amount.

The foaming effect is then applied in particular by the two components reacting with one another, and so can also be called chemical foaming. It is conceivable here for one reaction product of said reaction to induce a foaming process in the application material. For example, a gas such as carbon dioxide, which has an “expanding” effect, may be released. At the very latest upon deploying the application material, foaming of the same then takes place.

Resorting to two components which apply a foaming effect as a result of mixing or reacting with one another constitutes an easily regulatable way of varying the foaming effect, and so the pore size. Adjustment of the above ratio can take place by means of the simultaneous specific addition of two components with subsequent mixing. Alternatively, a component can be added (presented) in advance, while the other is added later (with subsequent mixing).

It is also preferred if a post-processing step takes place during the process on the external, i.e. accessible, segments of the volumetric body, which post-processing step includes in particular a post-machining step.

For this purpose, a milling unit or a grinding unit, for example, may be used, which unit provides the external segments with the desired surface finish.

Furthermore, it is preferred if the application material, when applied, is a pasty mass which comprises biological polymers, in particular lignin and natural fibres, the natural fibres preferably being formed from wood, flax, hemp, sisal, jute and/or other plant fibres.

This is advantageous especially when forming volumetric bodies for elements in the furniture industry because the substantially bio-based volumetric body then has usual and preferred properties for interior fittings and is very well biodegradable. Another advantage of this material is, furthermore, the possibility of specifying resource-saving production.

In this connection the expression “pasty” means that, when applied, the application material has a pasty consistency with corresponding viscosity. On the one hand this ensures easy processing of the application material when applied, and on the other hand guarantees that the application material can be connected optimally to already existing layers of the volumetric body or can optionally penetrate into the latter. Furthermore, excessive flowing of the application material can be prevented.

Different from this, but also conceivable, in particular in connection with an application material which is designed such that foaming is only initiated after said material is deployed, is the use of a substantially liquid application material which is associated with the advantage of improved creep ability.

Depending on the area of application, it may also be preferred if the application material comprises a metallic or mineral paste and/or a pasty plastic mass.

Such materials are advantageous in particular if harsh environmental conditions are anticipated because they provide the volumetric body with very good durability.

Furthermore, it should be noted that the application material is not restricted to the aforementioned examples. Other suitable foam materials from the domain of the components industry, such as for example PU foam or 2K foam, can be used.

Furthermore, the method according to a further development includes the step of coating external segments or the external segments of the volumetric body with a coating and/or printing external segments or the external segments of the volumetric body.

With these procedural steps the visual and haptic properties of the volumetric body can be adjusted with great flexibility without having to make any great compromises with regard to the weight of the volumetric body or the of the production speed.

As another aspect, a foamable application material is provided which includes two types of foaming agent, the first type applying its foaming effect at a first temperature, and the second type applying its foaming effect at a second temperature which is higher than the first temperature.

As another aspect, a volumetric body is furthermore provided which is formed from porous material and has a number of segments, the pore size (porosity) varying inconsistently in segments and in particular from segment to segment here. Preferably, internal segments (or the internal segments) have a larger pore size than external segments (or the external segments) of the volumetric body.

Furthermore, other aspects relate to the use of the aforementioned method for forming the aforementioned volumetric body and to the use of the foamable application material for forming the aforementioned volumetric body.

### BRIEF DESCRIPTION OF THE DRAWINGS

FIG. 1 schematically illustrates a device for forming a volumetric body.

FIG. 2 illustrates a cross section through a volumetric body.

### DETAILED DESCRIPTION OF PREFERRED EMBODIMENTS OF THE INVENTION

Preferred embodiments of the invention are described in detail below with reference to the accompanying drawings. Further modifications specified in this connection may respectively be combined with one another in order to form new embodiments.

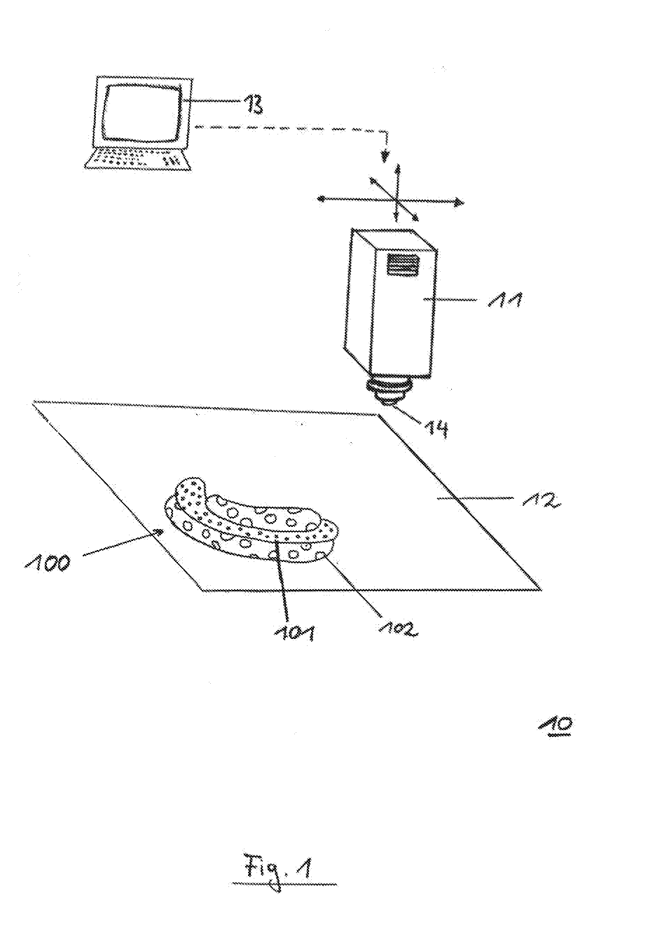

FIG. 1 illustrates a greatly simplified diagrammatic representation of a device 10 for forming volumetric bodies, and in particular for exemplarily implementing the method according to the invention.

The device 10 comprises a support 12 on which the volumetric body 100 is constructed. The volumetric body 100 is preferably constructed here by additively applying material step by step in different segments 101 and 102. In FIG. 1 this is illustrated by the different layers and segments 101 and 102 of the volumetric body 100.

An application unit 11 is provided for the material application. This unit is suitable for applying a defined amount of the application material at a defined position of the support 12 or to layers 101 and 102 of the volumetric body 100 which already exist.

The material is applied or the volumetric body is constructed additively here, i.e. new application material is applied precisely to application material which has already been applied. It is advantageous here if the application unit 11 can be moved in at least three spatial directions relative to the support 12. This is indicated by the arrows above the application unit 11 in FIG. 1. Furthermore, it may be advantageous for complicated volumetric bodies if the application unit 11 can, furthermore, be swiveled in two additional directions relative to the support 12 so that the application unit 11 can be aligned independently in five directions relative to the support 12, and this increases flexibility when forming the volumetric body 100. This works with an appropriate tool carrier (which is not shown however) in which the application unit 11 is received. This may be, for example, a five-axis tool carrier, for example a Cardanic five-axis head or a Cartesian five-axis head.

In addition, the device 10 has a control device 13 which is designed to control the application unit 11. This control includes both the positioning of the application unit 11 and the regulation of the actual application of the application material as well as the adjustment of the pore size by influencing the foaming of the application material.

The foaming can be induced, for example, by adding propellant gas, in particular nitrogen gas or carbon dioxide gas, or by activating an appropriate foaming agent which is added to the application material.

The control device 13 is designed such that it can adjust the pore size of the foamed application material in the volumetric body 100 depending on the respective segment 101, 102 of the volumetric body 100. For this purpose it influences the application unit 11 and accordingly adjusts, for example, the parameters with which the application material is applied.

Furthermore, the control device 13 can be designed such that it has an input device into which information (such as for example shape, size, desired strength, colour, hardness etc.) with regard to the three-dimensional volumetric body to be formed can be inputted, the control device 13 then being designed such that it calculates the corresponding segments of the volumetric body from this information. The segments can be calculated on the basis of geometric considerations, from aesthetic viewpoints (for example the identification of visible segments) or on the basis of stability considerations/calculations (for example structurally loaded segments can be identified here). In other words, the control device 13 can be designed such that it virtually segments the volumetric body to be formed into segments on the basis of the inputted information and correspondingly adjusts the pore size of the foamed application material for each of the segments of the volumetric body. In particular, one can fall back on CAD models here. These can then be provided with functional surfaces which e.g. predetermine the strength and colour or the surface finish.

As indicated in FIG. 1, the application unit 11 is preferably an extruder 11 for the deployment of the application material (i.e. the application material is deployed by an extruder).

The extruder 11 preferably delivers granular raw material of the application material that is heated towards an outlet opening 14. The raw material for the application material can be stored here in a storage container, that is not shown, which is connected to the extruder 11 by an appropriate connection element (for example a hose). As mentioned, the extruder 11 is received here in a tool holder which is not shown however.

In addition, the device may have additional machining tools which are either received in a separate tool holder or can be placed interchangeably in the tool holder of the extruder 11. These additional machining tools may, for example, include a machining unit for machining the volumetric body 100 or a device for coating or printing the volumetric body 100.

Further machining steps may then be performed on the volumetric body 100—either after completion of the material application or between a number of application processes. These machining steps may include, for example, machining such as the milling off or grinding down of segments of the volumetric body 100 or the coating or printing of segments of the volumetric body 100. These processes are also controlled by the control device 13 which is designed accordingly.

With regard to the application unit 11, the pore size of the application material is preferably adjusted continuously during the application of the latter. In this connection continuously means that the application itself must not be interrupted, but defined segments limits which may be discontinuous with regard to the pore size within the volumetric body 100 are nevertheless possible (if desired).

This type of adjustment (or generally the adjustment of the pore size) may take place in connection with the extruder 11 by using a propellant gas which is inputted into the delivery chamber of the extruder 11. This can take place by means of a separate supply line that is not illustrated. It is preferable here to add the propellant gas in cryogenic form, for example in the form of liquid nitrogen or dry ice. The foaming process is then initiated by vaporizing or sublimating the cryogenic propellant gas.

By varying the pressure (the amount) with which the propellant gas is inputted into the delivery chamber, and so into the application material, the pore size of the application material can then be varied. The use of propellant gas for foaming is then needless to say not restricted to the extruder 11 as the application unit.

Alternatively or in addition, a foaming agent can be added to the application material, which foaming agent preferably applies its foaming effect temperature-dependently by the supply of heat. This is advantageous because, for example, when using an extruder heating of the application material already takes place. If the foaming agent which is mixed with the application material is then designed such that it applies (i.e. activates) its foaming effect at a transition temperature, the pore size of the application material can be adjusted easily and precisely by varying the temperature of the application material within a range around the transition temperature. This temperature change is then undertaken by the control device 13.

The advantage of thus adjusting the pore size to above the temperature of the application material is that the temperature within the application unit 11 is in any case a parameter which is controlled during processing. Thus, for example, when using an extruder as an application unit, regulation of the temperature takes place by means of the pressure in the delivery chamber of the extruder (reduction of the internal friction by less delivery pressure). Furthermore, in order to obtain an appropriate processing temperature, additional (external) heating devices may already be provided in order to appropriately temper the application material.

In order to further support the targeted and especially rapid temperature change of the application material in this sense, the application unit 11 may have means for actively cooling and/or (additional) means for actively heating the application material.

Preferably, an application material is also used which comprises two types of foaming agent, the first type applying (i.e. activating) its foaming effect at a first temperature, and the second type applying (i.e. activating) its foaming effect at a second temperature which is different from the first temperature.

The second temperature can in particular be higher than the first temperature here. The pore size of the application material and the pore sizes of segments 101 and 102 of the volumetric body 100 are then adjusted by varying the temperature of the application material within a range around the second temperature. Below this second temperature only the first type is activated, and this leads to a lesser foaming effect than above the second temperature when both types are activated.

The range within which the temperature of the application material is varied is advantageously appropriately restricted here so that in particular rapid cooling to below the second temperature is achieved, and this allows a faster reaction time in the transition to smaller pore sizes and improves the production speed.

The range around the second temperature and the second temperature itself are chosen such that they come within a temperature spectrum which guarantees good processability of the application material. Advantageously, the range around the second temperature is, furthermore, restricted to close to the second temperature (e.g. the range has a range breadth of within a few % of the second temperature), and in particular the upper limit of the range is chosen such that it only comes slightly above the second temperature (e.g. the temperature upper limit of the range within which the temperature of the application material is varied lies a few % over the second temperature).

By thus limiting the range, a rapid reaction time when varying the pore size can be achieved, and this allows a faster reaction time, in particular in the transition to smaller pore sizes.

The statements made with regard to the range around the second temperature also apply to the transition temperature introduced above.

Alternatively or in addition, the foaming can be brought about or be initiated by means of a two-component system. Two components are added to the application material here, the two components being designed such that they unfold a foaming effect in order to foam the application material when they are mixed with one another (and in particular as a result of reacting with one another), and the foaming effect is dependent upon the ratio of the two components. The pore size of the foamed application material can then be adjusted by varying the ratio of the two components in the application material.

The above ratio can be adjusted by the simultaneous, targeted addition of the two components with subsequent mixing. With regard to the extruder 11, for this purpose this can have two separate supply lines (not shown) to the delivery chamber. The foaming is then initiated by mixing the two components with the aid of the conveyor screw of the extruder in the delivery chamber, and this triggers the reaction of the two components to one another. Alternatively, one component can be presented, whereas the other is added subsequently. Then only one supply line to the extruder is required.

Furthermore, it is conceivable for the application material to be designed such that it only foams due to reaction with oxygen in the air, for example releasing carbon dioxide.

For better manageability, the application is preferably pasty when applied. In other words, the application material is designed such that during or after application it is a pasty mass (or has a pasty consistency), and then hardens in the foamed state. Before hardening a viscosity range of, for example, 20,000 mPa·s to 100,000 mPa·s is suitable because this guarantees the required malleability when applying the application material.

For some applications, however, an initially liquid application material is also conceivable which additionally advantageously only foams upon contact with oxygen in the air, and then as gradually as possible. This type of application material has the advantage that it can penetrate particularly well into existing structures.

Preferably, the application material comprises a biopolymer which is characterized by biodegradability and is substantially bio-based by being produced, for example, by fermentative and/or polymer-chemical processes from sugar. In particular, the biopolymer comprises lignin.

Furthermore, natural resins, natural waxes, natural oils, cellulose and natural reinforcing fibres, such as for example wood fibres, flax fibres, hemp, sisal, jute, or other plant fibres may be contained in the application material. Furthermore, the application material may comprise polyhydroxalkanoates, polyhydroxylbutyrates, polycaprolactone, polyester and/or starch.

In particular biodegradable thermoplastics and thermoplastic polyesters, such as for example polyhydroxalkanoates, polyhydroxylbutyrates and polycaprolactone, are used as an additional thermoplastic portion.

By the curing of the initially pasty, foamed application material the application material solidifies in the corresponding segments 101, 102 of the volumetric body 100 with the adjusted pore size of the application material in the porous state adjusted in this way.

The curing of the application material generally takes place here without any additional process steps purely by the application material cooling by means of the cooler ambient air. However, it is also conceivable that the corresponding segments of the volumetric body are exposed for example to cooling air in order to accelerate curing or that a different curing technique is used depending on the material.

According to preferred embodiments the application material can be designed such that it can be cured by introducing energy. Thus, for example, a chemically cross-linking application material which can be cured by irradiating with infrared energy or laser light or by the effect of ultrasound energy is conceivable. By introducing energy, a cross-linking process, for example, can be induced in the material, by means of which the application material cures.

Accordingly, the device would then furthermore have mechanisms for applying energy (infrared energy, laser light or ultrasound energy) to the volumetric body, and the method would have the additional step of curing the application material by introducing energy.

Furthermore, the application material may comprise a metallic or mineral paste and/or a pasty plastic mass.

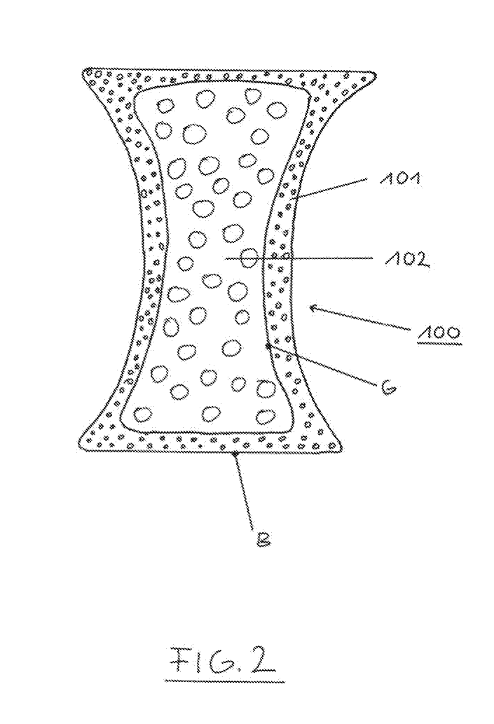

In FIG. 2, a volumetric body which can be formed by the device described above and the corresponding method is illustrated schematically in cross section. In particular, the present invention relates to volumetric bodies as elements for the furniture and components industry. The volumetric body that is illustrated can be understood to be, for example, a pedestal or a column for a table which has a complex geometry.

As shown in the drawing, the volumetric body has, for example, two segments 101 and 102 with different pore sizes. Segment 101 lies on the outside of the volumetric body here, i.e. it is accessible and visible from the outside. According to this example, segment 102 is entirely enclosed by segment 101.

The division of these segments can be undertaken, for example, by the control device 13 in consideration of the viewpoints expressed above.

The volumetric body is characterized in that there are different material porosities (pore sizes) in section 101 and section 102. Thus, there is greater porosity within the volumetric body than in the external regions. This makes it possible to form a particularly light volumetric body which nevertheless has an attractive surface structure due to the “shell segments” 101 and a high degree of strength and hardness.

It is characteristic of this additive method that the region of high porosity 102 may be entirely enclosed by a region of lower porosity 101—a configuration which can only be realized with difficulty, for example, due to the lamination of different layers of porous material.

The transition region G between the segments is a precisely defined transition region which can be characterized by a discontinuous change in the pore size due to the additive material application.

With regard to finishing, the volumetric body 100 may, furthermore, be provided with printing or coating B which covers the pores of the external segments 101. However, this coating B is optional and may also be omitted.

1. A method for forming volumetric bodies, in particular elements of pieces of furniture and/or elements of the building materials industry, comprising the steps:
foaming an application material;
applying the application material in order to form a volumetric body in several segments; and
adjusting the pore size of the foamed application material depending on the respective segment of the volumetric body.

2. The method according to claim 1, wherein the application constitutes an additive process in which the application material is applied successively in order to form the volumetric body successively, segment by segment.

3. The method according to claim 1, wherein the adjustment of the pore size of the foamed application material includes a variation of the pore size between the segments of the volumetric body, depending on the respective segment of the volumetric body.

4. The method according to claim 1, wherein the pore size is adjusted continuously during application.

5. The method according to claim 1, wherein the pore size is adjusted such that the foamed application material has a smaller pore size for external segments of the volumetric body than the foamed application material for internal segments of the volumetric body,
and in particular is adjusted such that the foamed application material for the external segments of the volumetric body has a smaller pore size than the foamed application material for the internal segments of the volumetric body.

6. The method according to claim 1, further comprising:
the addition of additives to the application material while or before applying the application material, the addition of additives taking place depending on the respective segment of the volumetric body.

7. The method according to claim 1, wherein
the foaming takes place by adding a propellant gas, in particular nitrogen, and
the pore size of the application material is adjusted by varying the addition of the propellant gas.

8. The method according to claim 1, wherein
foaming agents are mixed with the application material, which agents apply their foaming effect temperature-dependently, and
the pore size of the application material is adjusted by varying the temperature of the application material.

9. The method according to claim 1, wherein
two types of foaming agent are mixed with the application material, the first type applying its foaming effect at a first temperature, and the second type applying its foaming effect at a second temperature which is different from the first temperature, and
the pore size of the application material is adjusted by varying the temperature of the application material within a range around the second temperature.

10. The method according to claim 1, further comprising:
adding two components to the application material, the two components being designed so that when mixed with one another, and in particular by reacting with one another, they apply a foaming effect for foaming the application material, and the foaming effect is dependent upon the ratio of the two components; and adjusting the pore size of the application material by varying the ratio of the two components in the application material.

11. The method according to claim 1, further comprising:
a step of post-processing, in particular machining, the external segments of the volumetric body.

12. The method according to claim 1, wherein the application material is a pasty mass which comprises a mixture of biological polymers, in particular lignin and natural fibres, the natural fibres preferably being formed from wood, flax, hemp, sisal, jute and/or other plant fibres.

13. The method according to claim 1, wherein the application material comprises a metallic or mineral paste and/or a pasty plastic mass.

14. The method according to claim 1, further comprising:
coating external segments of the volumetric body with a coating and/or printing external segments of the volumetric body.
